(19) United States
(12) Patent Application Publication
(10) Pub. No.: US 2017/0191196 A1
(43) Pub. Date: Jul. 6, 2017

(54) WADDING

(71) Applicant: Mitsubishi Rayon Co., Ltd., Tokyo (JP)

(72) Inventors: Shima NAKANISHI, Otake-shi (JP); Yukio ONOHARA, Otake-shi (JP); Tatsuhiko INAGAKI, Otake-shi (JP); Hideaki KOBAYASHI, Osaka (JP)

(73) Assignee: Mitsubishi Rayon Co., Ltd., Toyko (JP)

(21) Appl. No.: 15/308,691

(22) PCT Filed: May 8, 2015
(86) PCT No.: PCT/JP2015/063312

§ 371 Date: Nov. 3, 2016

(30) Foreign Application Priority Data
May 8, 2014 (JP) 2014-096581
Oct. 24, 2014 (JP) 2014-217375

(51) Int. Cl. D04H 1/02; B68G 1/00; D06M 15/643; D04H 1/43; D04H 1/54

(52) U.S. Cl. CPC D04H 1/02; D04H 1/43; D04H 1/54; D06M 15/643; B68G 1/00; D10B 2505/08

(57) ABSTRACT

The present invention relates to wadding in which short fibers (A) having a single fiber fineness (a) of 0.001-1.0 dtex make up 5-90 mass % of the total mass of the wadding. Measured in accordance with JIS L 1096 Warmth Retention Method A (Constant-Temperature Method):2010, a 89% or higher warmth retention ratio is obtained in test items made by stuffing 100 g of the wadding substantially evenly into a pouch-shaped cover produced by layering two pieces of 45 cm-length 100% cotton fabric squares and thereafter sewing shut the opening of the pouch-shaped cover. By means of the present invention, it is possible to provide wadding which has excellent softness and bulkiness and which is ideal for use in down jackets, duvets or other bedding.

### TECHNICAL FIELD

The present invention relates to a wadding to be used for comforters or other beddings, down jackets and the like. The present application is based upon and claims the benefit of priority to Japanese Patent Application Nos. 2014-096581, filed May 8, 2014, and 2014-217375, filed Oct. 24, 2014, the entire contents of which are incorporated herein by reference.

### BACKGROUND ART

Feathers mainly used as a wadding for beddings, down jackets and the like are known to be rich in texture, lightweight, and excellent in heat-retention and bulkiness properties, and to show a high recovery rate after being compressed. However, to obtain feathers, it is necessary to breed a large number of waterfowl, which requires a large amount of feed. Moreover, breeding a large number of waterfowl results in water pollution from their excrement, which in turn causes problems such as the occurrence and spread of infectious diseases. In addition, to prepare for use as a wadding, feathers need to go through multiple steps such as collecting, sorting, disinfecting and degreasing procedures. Furthermore, feathers tend to fly up in the air during processing steps, causing complications in the procedures. Accordingly, bedding prices tend to be high when feathers are used as the wadding.

As alternative material for a wadding, polyester fibers may be used. Polyester fibers are inexpensive and lightweight with excellent bulkiness; a problem, however, is that the compression recovery rate is low.

To deal with such a problem, studies are underway to provide bulkiness for synthetic fibers such as polyester fibers. For example, Patent Literature 1 proposes a hard wadding structure that exhibits improved rigidity and elasticity obtained when a predetermined amount of a surface treatment agent, which mainly contains a polyether-ester block copolymer, is adhered to surfaces of both the matrix fibers of the fiber structure and heat-adhesive short fibers. However, the hard wadding structure described in Patent Literature 1 lacks softness due to its high rigidity, and is not preferable for use in applications such as comforters and jackets that require softness to easily conform to the body line.

Patent Literature 2. proposes a wadding formed with a layer made of fibers with a single fiber fineness of 1.5 denier or lower, which is laminated with another layer made of fibers with a single fiber fineness of 2.5˜15 denier. However, since the wadding is formed only by layering fibers having a smaller single fiber fineness (web) and another type of fibers having a larger single fiber fineness (web), excellent compression recovery rates as evidenced with feathers are not achieved. In addition, since fibers having different levels of fineness are not intertwined, hardly any effects on bulkiness are expressed despite using fibers with two different levels of fineness. Here, “web” means a sheet of overlapping fibers.

Patent Literature 3 proposes a wadding formed by blending short fibers with a single fiber fineness of at least 0.5 dtex but less than 3.0 dtex, hollow fibers with a fineness of at least 5.0 dtex but less than 10.0 dtex, hollow fibers with a fineness of at least 10.0 dtex but less than 30.0 dtex, and heat-adhesive short fibers with a fineness of at least 1.0 dtex but less than 5.0 dtex. According to the wadding of Patent Literature 3, short fibers with a single fiber fineness of at least 0.5 dtex but less than 3.0 dtex contribute to providing a heat-retention property, and short fibers with a single fiber fineness of at least 5.0 dtex contribute to providing heat-retention and bulkiness properties. However, even the wadding related to Patent Literature 3 is not capable of achieving sufficient bulkiness.

### CITATION LIST

### Patent Literature

Patent Literature 1: JP4043492B

Patent Literature 2.: JP S63-23797B

Patent Literature 3: JP2013-177701A

### SUMMARY OF THE INVENTION

### Problems to Be Solved

The objective of the present invention is to solve the aforementioned problems identified in conventional art and to provide a wadding that exhibits excellent bulkiness and softness and is suitable for use in applications such as down jackets and comforters or other beddings.

### Solutions to the Problem

The aspects of the present invention are as follows.
<1> A wadding, containing short fibers (A) with a single fiber fineness of 0.001 dtex˜1.0 dtex at 5˜90 mass % of the total mass of the wadding, and having a heat-retention rate of 89% or higher, which is determined in accordance with JIS L1096: 2010, Method A: measuring heat-retention rate (constant temperature method) for testing a sample piece prepared by substantially homogeneously stuffing 100 grams of the wadding into a pouch-shaped cover formed with two sheets of a 45 cm×45 cm square 100% cotton fabric and then by seaming the opening of the cover.
<2> The wadding according to <1>, having a bulkiness of 180 mm or greater.
<3> The wadding according to <1> or <2>, having a heat-retention rate of 93% or higher.
<4> The wadding according to any of <1>˜<3>, containing short fibers (B) with a single fiber fineness (b) of 0.8 dtex˜20 dtex at 10˜95 mass % of the total mass of the wadding, in which the single fiber fineness (a) of short fibers (A) and the single fiber fineness (b) of short fibers (B) satisfy a relationship of (b)≧1.5(a).
<5> The wadding according to <4>, in which the single fiber fineness (b) of short fibers (B) is 1.3˜2.8 dtex.
<6> The wadding according to any of <1>˜<5>, in which the number of neps existing in 1 gram of the wadding is 30 or greater.
<7> The wadding according to any of <1>˜<6>, in which the single fiber fineness (a) of short fibers (A) is at least 0.001 dtex but less than 0.4 dtex.
<8> The wadding according to any of <1>˜<5>, in which the single fiber fineness (a) of short fibers (A) is at least 0.4 dtex but no greater than 1.0 dtex.
<9> The wadding according to any of <1><8>, in which the length of short fibers (A) is 20˜60 mm, and the length of short fibers (B) is 20˜60 mm.
<10> The wadding according to any of in which polysiloxane is adhered to short fibers (A) at 0.1˜15.0 mass % of the total mass of the short fibers (A).
<11> The wadding according to any of <1>˜<10>, in which short fibers (A) are acrylic fibers.
<12> The wadding according to any of <1>˜<11>, containing heat-adhesive short fibers at 5˜40 mass % of the total mass of the wadding, in which at least some of the heat-adhesive short fibers are adhered to short fibers (A).

### EFFECTS OF THE INVENTION

According to the present invention, problems identified in conventional technology are solved, and a wadding that exhibits excellent bulkiness, softness, and heat-retention properties is provided to be used preferably in applications such as down jackets and comforters or other beddings.

### DETAILED DESCRIPTION OF THE EMBODIMENTS

The present invention is described below in detail.

An embodiment of the present invention is a wadding containing short fibers (A) with a single fiber fineness (a) of 0.001 dtex˜1.0 dtex at 5˜90 mass % of the total mass of wadding.

When the wadding contains short fibers (A) with a single fiber fineness (a) of at least 0,001 dtex but less than 0.4 dtex, neps are formed using the short fibers (A) as cores during a processing step of wadding (fiber opening step, carding step, or packing step of a wadding). A “nep” is a small knot formed when part of one or multiple fiber portions is entangled, and is defined as having a diameter of 1˜5 mm and not standing independently. Neps perform the same function as down balls in down feathers. A “down ball” refers to something that has a spherical shape formed when barbs of feathers are extended radially, and is capable of holding more air than otherwise. Namely, neps formed with short fibers (A) improve the bulkiness of a wadding, and it is easier to prevent the wadding stuffed in comforters or down jackets from shifting during washing.

In an embodiment of the present invention, the single fiber fineness (a) of short fibers (A) is preferred to be at least 0.001 dtex, because a soft texture similar to that of feathers is obtained. In addition, the single fiber fineness (a) of short fibers (A) is preferred to be less than 0.4 dtex, since the aforementioned neps tend to be formed.

From the viewpoints above, the single fiber fineness (a) of short fibers (A) is more preferred to be 0.01 dtex˜0.3 dtex, especially preferably 0.05 dtex˜0.2 dtex.

In the present application, “single fiber fineness” refers to a value measured in accordance with JIS 1.1015:2010.

The wadding is preferred to contain short fibers (A) with a single fiber fineness of at least 0.4 dtex but no more than 1.0 dtex. Although neps are not formed in such a wadding, more air layers are formed among fibers, thus enhancing bulkiness and heat-retention properties. From such viewpoints, the single fiber fineness (a) of short fibers (A) is more preferred to be 0.6˜0.9 dtex, even more preferably 0.7˜0.8 dtex.

In an aspect of the present invention, short fibers (A) may be a blend of short fibers having different levels of single fiber fineness. When short fibers (A) are a blend of multiple types of short fibers, the single fiber fineness of each type of short fibers is preferred to be within the range of single fiber fineness (a), namely, between 0.001 dtex˜1.0 dtex.

In another aspect of the present invention, when short fibers (A) are a blend of short fibers each having a single fiber fineness of at least 0.001 dtex but less than 0.4 dtex as described above, the content of other types of short fibers is preferred to be 20˜100 mass %, more preferably 30˜80 mass % of the total mass of short fibers (A).

In yet another aspect of the present invention, When short fibers (A) are a blend of short fibers each having a single fiber fineness of at least 0.4 dtex but no more than 1.0 dtex as described above, the content of other types of short fibers is preferred to be 20˜100 mass %, more preferably 30˜80 mass % of the total mass of short fibers (A).

In another embodiment of the present invention, the content of short fibers (A) is 5˜90 mass % of the total mass of the wadding.

The content of short fibers (A) is preferred to be 5˜90 mass % of the total mass of the wadding, because the bulkiness and heat-retention properties are enhanced.

From the above viewpoints, the content is more preferred to be 10˜80 mass %, even more preferably 20˜60 mass %.

The single fiber fineness (a) of 0.001 dtex˜1.0 dtex of short fibers (A) is significantly finer than that of fibers to be used in apparel applications. When short fibers (A) with such a level of single fiber fineness are blended at 5˜90 mass % of the total mass of a wadding, softness of the wadding is enhanced.

It is an option to set the content of short fibers (A) at 100 mass % relative to the total mass of a wadding. However, to achieve bulkiness, softness and heat-retention properties for a wadding, the content of short fibers (A) is preferred to be set in the aforementioned range.

Short fibers (A) are not limited to any particular type; examples are synthetic fibers such as acrylic, polyester, nylon, acetate, rayon and cuprammonium fibers; animal fibers such as wool; and so forth. Among them, acrylic fibers are preferred, considering their heat-retention property.

A wadding related to the present invention has a heat-retention rate of 89% or higher, when measured in accordance with JIS L1096:2010, Test Method A: measuring heat-retention rate (constant temperature method): a sample piece of the wadding for testing is prepared by substantially homogeneously stuffing 100 grams of a wadding into a pouch-shaped cover formed with two sheets of a 45 cm×45 cm square 100% cotton fabric and by seaming the opening of the cover. Since the wadding related to the present invention has a heat-retention rate of 89% or higher, it is capable of producing products having a high heat-retention rate without using much of the wadding. From the viewpoints above, the heat-retention rate is more preferred to be 91% or higher, even more preferably 93% or higher.

In yet another embodiment of the wadding related to the present invention, its bulkiness (height) is preferred to be 180 mm or greater.

When the bulkiness is 180 mm or greater, the product manufactured by using the wadding is made lightweight, and the heat-retention rate is likely to be higher.

From the above viewpoints, the bulkiness is more preferred to be 200 mm or greater, even more preferably 220 mm or greater.

The bulkiness of the wadding related to the present invention may be measured as follows.

### (Method for Measuring Bulkiness)

(1) Collect 1.5 grams of a wadding that has been kept standing in a 100° C. ambience for 30 minutes;
(2) Divide the wadding into approximately 0.15-gram batches and drop them softly into a 1000-mL graduated cylinder with a 65 mm diameter so as to fill the cylinder homogeneously without causing any gap;
(3) Lower a 6-gram loading disc into the cylinder to exert a homogeneous load on the wadding and keep the disc in position for 2 minutes; and
(4) Measure the height (mm) from the bottom of the cylinder to the lowest point of the loading disc, and set the height as the bulkiness.

The above measuring process is conducted on three samples and the average value is set as the bulkiness of the wadding.

In another embodiment of the present invention, it is preferred for a wadding to contain short fibers (B) with a single fiber fineness (b) of 0.8 dtex˜20 dtex at 10-95 mass % of the total mass of the wadding.

The wadding related to the present invention is preferred to be a blend of short fibers (A) and (B). When short fibers (B) having a single fiber fineness (b) of 0.8 dtex˜20 dtex are blended with short fibers (A), the size of a nep is enlarged, and the bulkiness and compression recovery rate of the wadding are further improved.

Short fibers (B) are not limited to any particular type; examples are synthetic fibers such as acrylic, polyester, nylon, acetate, rayon and cuprammonium fibers; animal fibers such as wool; and so forth. Among them, acrylic fibers are preferred, considering their heat-retention property.

Short fibers (B) to be blended with short fibers (A) may be selected appropriately according to usage purposes or desired properties. For example, the bulkiness of a wadding is enhanced by blending side-by-side bicomponent fibers so as to express a self-crimping property; the bulkiness and heat-retention properties of a wadding are enhanced by blending fibers having a V-shaped cross section; and the like. Furthermore, antibacterial fibers, deodorant fibers, moisture-absorbing exothermic fibers, optical exothermic fibers, flame retardant fibers or the like may be blended in to enhance functions respectively assigned to such fibers. Those types of fibers may be used alone or in combination thereof.

Regarding the single fiber fineness (h) of short fibers (B), it is preferred to be 0.8 dtex or more, since a higher compression recovery rate is easier to achieve; and it is preferred to be 20 dtex or less, since bulkiness is more likely to be achieved while the texture tends not to be stiff. From such viewpoints, the single fiber fineness (b) of short fibers (B) is more preferred to be 1˜5 dtex, even more preferably 1.3˜2.8 dtex.

The content of short fibers (B) in a wadding is preferred to be 10˜95 mass %, more preferably 40˜80 mass %, of the total mass of the wadding. If the content of short fibers (B) in a wadding is 10˜95 mass % of the total mass of the wadding, bulkiness is more likely to be achieved. From such a viewpoint, the content of short fibers (B) is more preferred to be 30˜90 mass %, even more preferably 40˜80 mass %.

In addition, the width of short fibers (B) to be blended with short fibers (A) is preferred to be greater than that of short fibers (A), when bulkiness and compression recovery rate are considered. Namely, the single fiber fineness (a) of short fibers (A) and the single fiber fineness (b) of short fibers (B) are preferred to satisfy a relationship of (b)≧1.5(a).

When the single fiber fineness (a) and the single fiber fineness (h) satisfy the relationship (b)≧1.5(a), the bulkiness of a wadding is easier to enhance. From such a viewpoint, the single fiber fineness (a) and the single fiber fineness (h) are more preferred to satisfy a relationship of (b)≧2.0(a), even more preferably (b)≧2.5(a).

The number of neps in 1 gram of a wadding is preferred to be 30 or greater in the present embodiment.

By setting the number of neps at 30 or greater, when washing beddings or down jackets formed by stuffing a wadding related to the present invention, fibers are less likely to become entangled, and shifting of the wadding is reduced. The number of neps in I gram of a wadding is not limited to any specific upper limit. However, a greater number of neps may cause broken or snapped fibers and result in entangled fibers. Also, since a higher nep density in fibers tends to cause a lower bulkiness, the number of neps is preferred to be 200 or fewer.

The number of neps in 1 gram of a wadding is determined as follows: after the wadding is kept standing for an hour in a room set to have room temperature (25° C.) and humidity of 65%, 1 gram of the wadding is divided and thinly spread so that the number of neps in the wadding can be visually counted.

In yet another embodiment of the wadding related to the present invention, the length of the above short fibers (A) is preferred to be 20˜60 mm. The length of short fibers (A) is preferred to be at least 20 mm, since processability is excellent during the processing steps, neps to become cores are more likely to be formed, fibers are less likely to entangle after being washed, and shifting of the wadding is reduced. Also, the length of short fibers (A) is preferred to be no greater than 60 mm, since problems such as fiber wrapping are reduced in each step. The length of short fibers (A) is more preferred to be 30˜50 mm, even more preferably 35˜45 mm.

In addition, the length of short fibers (B) is preferred to be 20˜60 mm. The length of short fibers (B) is preferred to be at least 20 mm, since excellent processability is obtained during the processing steps, and bulkiness is more likely to be enhanced. The length of short fibers (B) is preferred to be no greater than 60 mm, since problems such as fiber wrapping are reduced in each step. The length of short fibers (B) is more preferred to be 30˜55 mm, even more preferably 35˜45 mm.

Here, “length of fiber” refers to the length in a fiber axial direction.

Moreover, in yet another embodiment of the present invention, to enhance the bulkiness and softness of a wadding, polysiloxane is preferred to be attached at 0.1˜15.0 mass % relative to the total mass of short fibers (A).

A method for attaching polysiloxane to short fibers (A) is to apply a lubricant containing polysiloxane on the surfaces of short fibers (A). When the lubricant containing polysiloxane is applied on the surfaces of short fibers (A), the smoothness of the fibers is enhanced and friction among fibers is alleviated, thus making it easier for the fibers to move. Accordingly, softness is enhanced while bulkiness is improved, since felt-like formations caused by entangled fibers are prevented from occurring in fibers when the wadding is compressed.

In vet another embodiment of the present invention, the amount of polysiloxane attached to short fibers (A) is preferred to be 0.1˜15.0 mass %, more preferably 0.3˜8.0 mass %, especially preferably 0.5˜5.0 mass %, of the total mass of short fibers (A). The amount of attached polysiloxane is preferred to be in the above range in order to obtain the aforementioned results.

Examples of polysiloxane to be attached to short fibers (A) are amino-modified silicone and the like. Such examples may be used alone or in combination thereof.

To apply a lubricant containing polysiloxane to short fibers (A) in a step for cutting the short fibers (A) at a predetermined length, a lubricant containing polysiloxane may be applied onto short fibers (A) after the fiber tow is cut into pieces of a predetermined length; or the oil agent may be applied prior to cutting the tow, and then the tow is dried and cut into pieces.

Regarding short fibers (B) to be blended with short fibers (A), softness is also enhanced when polysiloxane, the same as above, is applied thereon.

In the present application, a “short fiber” refers to a fiber obtained by cutting a tow of fibers into pieces having a preferred length, namely, a “fiber after being cut short.”

In yet another embodiment of the present invention, short fibers (A) are preferred to be acrylic fibers. Because of the heat-retention and moisture-absorbing properties and lightweight features of acrylic fibers, characteristics desired in various applications are further enhanced.

In yet another embodiment of the present invention, the wadding is preferred to contain heat-adhesive short fibers at 5˜10 mass %, and at least some of the heat-adhesive short fibers are preferred to be adhered to short fibers (A) in view of bulkiness and the compression recovery rate. In addition, at least sonic of the heat-adhesive short fibers are preferred to be adhered to short fibers (A), since it is easier to retain the neps formed therein.

For forming heat-adhesive fibers, it is preferred to use a resin having a lower melting point than those of short fibers (A) and (B), more preferably to use a type of short fibers made of a resin having a low-melting point of 100˜200° C. Specific preferred examples are short fibers formed from low-melting polyesters obtained by copolymerizing polyethylene terephthalate or polybutylene terephthalate with isophthalic acid, adipic acid, cyclohexane dicarboxylic acid, sebacic acid or the like. After neps to become cores are formed, it is easier to retain the neps if the heat-adhesive short fibers are added and adhered to some of short fibers (A) by applying heat. However, since short fibers (A) related to the present invention have a significantly small single fiber fineness (a) and are capable of preventing the neps from becoming unraveled, the application of heat-adhesive short fibers may be decided based on the level of durability required for fiber products.

Next, a method for manufacturing a wadding is described according to the present invention.

In an embodiment of the present invention, a wadding is manufactured by the following steps: short fibers (A) consisting of extra fine fibers with a single fiber fineness (a) of 0,001 dtex˜1.0 dtex, which are layered with any type of short fibers (B), are passed through a fiber opener; and the opened fibers are blended by an airlaying and/or a carding process. In another embodiment of the present invention, the method for manufacturing a wadding may include a step for applying polysiloxane on short fibers (A) and a step for adhering heat-adhesive short fibers to some of short fibers (A).

To manufacture short fibers (A) with a single fiber fineness (a) of 0.001 dtex˜1.0 dtex, the following method, for example, may be employed: Step-A: prepare a solution by dissolving a polyacrylonitrile copolymer in dimethylacetamide, and discharge the copolymer solution in an aqueous solution of dimethylacetamide by using a nozzle with discharge ports so as to obtain coagulated ⁻fibers; Step-B: stretch the coagulated fibers by wet heat drawing or dry heat drawing or by both \vet and dry heat drawing, wash the fibers in boiling water, apply a lubricant, and dry the fibers at 100˜200° C. to mechanically provide crimps (two-dimensional crest-valley structure) so as to finally obtain a type of fibers with a single fiber fineness of 0.001 dtex˜1.0 dtex; Step-C: if applicable, further conduct thermal relaxation treatment and/or mechanically provide crimps for the fibers by using a crimper; and Step-D: obtain short fibers (A) by cutting the fibers after step-C to have a fiber length of 20˜60 mm. In step-C, crimps are preferred to be mechanically provided by using a crimper, and the number of crimps is preferred to be 3˜20/25 mm in view of obtaining bulkiness.

In the above manufacturing method, the percentage of a polyacrylonitrile copolymer to be dissolved in dimethylacetamide is preferred to be 10˜30 mass %, more preferably 15˜23 mass %, of the solution.

The hole diameter of the discharge ports of the nozzle is preferred to be 0.010˜0.080 mm, more preferably 0.015˜0.060 mm.

The dimethylacetamide concentration in the dimethylacetamide solution is preferred to be 10˜80 mass %, more preferably 20˜60 mass %.

In addition, the draw ratio of the coagulated fibers is preferred to be 2.0˜8.0 times, more preferably 3.0˜6.5 times.

When the method for manufacturing a wadding includes a step for applying polysiloxane, a lubricant containing polysiloxane such as amino-modified silicone is sprayed onto short fibers (A) obtained in step-D above, or the short fibers (A) are treated in a solution that includes a lubricant containing polysiloxane, to have a polysiloxane concentration of 0.1˜15.0 mass % of the total mass of short fibers (A), and then the fibers are dried.

Moreover, when the method for manufacturing a wadding includes a step for adhering heat-adhesive short fibers to short fibers (A), it is preferred to blend the short fibers (A) obtained in step-D with heat-adhesive short fibers and to apply heat on the fibers at 100˜200° C. so that neps are fixed to the fibers.

In a wadding according to yet another embodiment of the present, short fibers (A) made of extra fine fibers with a single fiber fineness (a) of 0.001 dtex˜1.0 dtex are contained at 5˜90 mass % of the total mass of the wadding. In addition, at least 50 mass % of the short fibers (A) are preferred to have a length of 20˜60 mm.

### EXAMPLES

In the following, the present invention is described in detail by referring to examples and comparative examples. However, the present invention is not limited to those examples.

### (Measuring Single Fiber Fineness)

The single fiber fineness was measured in accordance with JIS L1015: 2010.

### (Method for Measuring Bulkiness)

(1) Collect 1.5 grams of a wadding that has been kept standing in a 100° C. ambience for 30 minutes;
(2) Divide the wadding into approximately 0.15-gram batches and drop them softly into a 1000-ink graduated cylinder with a 65 nun diameter so as to fill the cylinder homogeneously without causing any gap;
(3) Lower a 6-gram loading disc into the cylinder to exert a homogeneous load on the wadding and keep the disc in position for 2 minutes; and
(4) Measure the height (mm) from the bottom of the cylinder to the lowest point of the loading disc, and set the height as the bulkiness.

The above measuring process was conducted on three samples and evaluated. The average value was set as the bulkiness of the wadding.

### (Method for Determining Softness)

Five persons skilled in the art touched the wadding by hand to evaluate its softness according to the three-level criteria below, and the average value was calculated.

A: significantly soft (5 points)

B: soft (3 points)

C: hard (1 point)

The symbol “-” in the tables indicates no measurement was taken.

### (Method for Measuring Heat-Retention Rate)

(1) Prepare a sample piece by stuffing 100 grams of a wadding substantially homogeneously into a pouch-shaped cover formed with two sheets of a 45 cm×45 cm square fabric (100% cotton) and then by seaming the opening of the cover. A woven fabric with a base weight of 188 g/m² was used here.
(2) To determine the heat-retention rate, follow the steps specified in JIS L1096:2010, Test Method A for measuring the heat-retention rate (constant-temperature method) after the sample piece was attached to a constant-heat device.

The higher the heat-retention rate is, the better is the heat-retention property.

The symbol “-” in the tables indicates no measurement was taken.

### (Counting the Number of Neps)

The number of neps in 1 gram of a wadding was counted as follows.

After a wadding was kept standing for an hour in a room set to have a room temperature (25° C.) and humidity of 65%, 1 gram of the wadding was divided and thinly spread so that the number of neps in the wadding was visually counted.

### Example 1

A copolymer consisting of an acrylonitrile unit content of 95 mass % and a vinyl acetate unit content of 5 mass % was dissolved in dimethylacetamide to have a copolymer concentration of 20 mass %. Then, using a nozzle having 0.050 mm diameter round discharge ports, the copolymer solution was discharged into a 30 mass % dimethylacetamide solution for coagulation. Fibers were obtained after a wet heat drawing was conducted at a draw ratio of 6.5 times, followed by washing in boiling water. A tow was prepared by applying a lubricant to the fibers, and was then dried using multiple dry rolls with a surface temperature of 150° C. Then, thermal relaxation treatment was conducted and crimps were mechanically provided by using a crimper to form 12 crimps/25 mm. Short fibers (A) were obtained by cutting the tow to have a fiber length of 38 mm. The short fibers (A) were immersed in a solution containing polysiloxane (Marposilcoat EX-G5, made by Matsumoto Yushi-Seiyaku Co., Ltd.), and dried to obtain short fibers (A) with a single fiber fineness of 0.1 dtex and an amount of attached siloxane of 3.0 mass % (short fibers (A1).

Then, 50 mass % of short fibers (A1) and 50 mass % of acrylic fibers as short fibers (B) (made by Mitsubishi Rayon Co., Ltd., item type: H815, single fiber fineness: 2.2 dtex, fiber length: 51 mm) were blended using a blender, and were passed through a fiber opener. After fibers were carded, a wadding was obtained.

The wadding was evaluated for its bulkiness, softness and heat-retention rate. Evaluation results are shown in Table 1.

### Examples 2˜9

Waddings were manufactured the same as in Example 1 except that the type and ratio of short fibers (B) to be blended with short fibers (A1) were respectively changed as shown in Table 1. The bulkiness and softness of each wadding are shown in Table 1. Details for fibers listed in Table 1 are as follows.
acrylic fibers with a Y-shaped cross section (made by Mitsubishi Rayon, item type: HS42, single fiber fineness: 6.6 dtex, fiber length: 38 mm)
side-by-side bicomponent acrylic fibers (made by Mitsubishi Rayon, item type: MW66, single fiber fineness: 2.2 dtex, fiber length: 38 mm)

### Example 10

A copolymer consisting of an acrylonitrile unit content of 95 mass % and a vinyl acetate unit content of 5 mass % was dissolved in dimethylacetamide to have a copolymer concentration of 15 mass %. Then, using a nozzle having 0.015 mm diameter round discharge ports, the copolymer solution was discharged into a 30 mass % dimethylacetamide solution for coagulation. Fibers were obtained after a wet heat drawing was conducted at a draw ratio of 6.0 times, followed by washing in boiling water. A tow was prepared by applying a lubricant to the fibers, and was then dried using multiple dry rolls with a surface temperature of 150° C. Then, thermal relaxation treatment was conducted and crimps (two-dimensional crest-valley shape) were mechanically provided by using a crimper to form 15 crimps/25 mm. Short fibers (A) were obtained by cutting the tow to have a fiber length of 38 mm. The short fibers (A) were immersed in a solution containing polysiloxane (Marposilcoat EX-G5 , made by Matsumoto Yushi-Seiyaku Co., Ltd.), and dried to obtain short fibers (A) with a single fiber fineness of 0.005 dtex and an amount of attached polysiloxane of 3.0 mass % (short fibers (A2)).

Then, 50 mass % of short fibers (A2) and 50 mass % of acrylic fibers as short fibers (B) (made by Mitsubishi Rayon, item type: H1815, single fiber fineness: 2.2 dtex, fiber length: 51 mm) were blended using a blender, and were passed through a fiber opener. After the fibers were carded, a wadding was obtained,

The wadding was evaluated for its bulkiness and softness. Evaluation results are shown in Table 1.

### Examples 11˜13

Waddings were manufactured the same as in Example 10 except that the type and ratio of short fibers (B) to be blended with short fibers (A2) were respectively changed as shown in Table 1. The bulkiness and softness of each wadding were evaluated, and the results are shown in Table 1 and 2.

### Examples 14˜16

Waddings were manufactured the same as in Example 1 except that the length of short fibers (A1) of Example 1 and the type of short fibers (B) were respectively changed as shown in Table 2. The bulkiness and softness of each wadding were evaluated, and the results are shown in Table 2.

### Examples 17˜18

Waddings were manufactured the same as in Example 1 except that the amount of polysiloxane attached to short fibers (A1) of Example 1 and the type of short fibers (B) were respectively changed as shown in Table 2. The bulkiness and softness of each wadding were evaluated, and the results are shown in Table 2.

### Example 19

Fifty mass % of acrylic fiber (made by Mitsubishi Rayon, item type: H616, single fiber fineness: 0.8 dtex, fiber length: 38 Mal: short fibers (A3)) as short fibers (A) and 50 mass % of acrylic fiber (made by Mitsubishi Rayon, item type: H815, single fiber fineness: 2.2 dtex, fiber length: 51 nun) as short fibers (B) were blended using a blender. The fibers were then passed through a fiber opener and carded by a carding machine. Accordingly, a wadding was obtained.

The bulkiness and heat-retention rate of the wadding were evaluated, and the results are shown in Table 2.

### Examples 20˜21

Waddings were manufactured the same as in Example 19 except that the type and ratio of short fibers (B) to be blended with short fibers (A3) were respectively changed as shown in Table 2. The bulkiness and heat-retention rate of each wadding were evaluated, and the results are shown in Table 2.

### Examples 22˜23

Waddings were manufactured the same as in Example 19 except that the type of short fibers (B) to be blended with short fibers (A3) was changed as shown in Table 2. The bulkiness and heat-retention rate of each wadding were evaluated, and the results are shown in Table 2.

Details for acrylic fibers with a cross-shaped cross section and acrylic fibers with a flat cross section in Table 2 are as follows:
acrylic fibers with a cross-shaped cross section (made by Mitsubishi Rayon, single fiber fineness: 2.2 dtex, fiber length: 38 mm)
acrylic fibers with a flat cross section (made by Mitsubishi Rayon, item type: HS08, single fiber fineness: 17 dtex, fiber length: 38 mm)

### Example 24

A wadding was prepared the same as in Example 19 except that acrylic fibers (made by Mitsubishi Rayon, item type: H616, single fiber fineness: 1.0 dtex, fiber length: 38 mm, short fibers (A4)) were used as short fibers (A), and side-by-side bicomponent acrylic fibers (made by Mitsubishi Rayon, item type: MW66, single fiber fineness: 2,2 dtex, fiber length: 38 mm) were used as short fibers (B). The bulkiness and softness of the wadding were evaluated, and the results are shown in Table 2.

### Comparative Examples 1˜6

Waddings were prepared the same as in Example 1 except that fibers listed in Table 3 were used. The bulkiness, softness and heat-retention rate of each wadding were evaluated, and the results are shown in Table 3.

TABLE 1

| | Short fibers A | | | | | | | | | | | |
|---|---|---|---|---|---|---|---|---|---|---|---|---|
| | | | amount of | Short fibers B | | | | | | | | |
| | single | length | adhered | | single | length | Ratio of | Ratio of | | | Heat- | |
| | fiber | of short | poly- | | fiber | of short | short | other | Bulki- | Soft- | reten- | # of neps |
| | fineness | fibers | siloxane | type of | fineness | fibers | fibers A | fibers | ness | ness | tion | (per 1 g of |
| | (dtex) | (mm) | (mass %) | fibers | (dtex) | (mm) | (mass %) | (mass %) | (mm) | (point) | rate (%) | wadding) |
| Example 1 | 0.1 | 38 | 3.0 | regular | 2.2 | 51 | 50 | 50 | 281 | 4.6 | 93.3 | 30 or more |
| | | | | acrylic fibers | | | | | | | | |
| Example 2 | 0.1 | 38 | 3.0 | regular | 2.2 | 51 | 70 | 30 | 270 | 5.0 | 93.0 | 30 or more |
| | | | | acrylic fibers | | | | | | | | |
| Example 3 | 0.1 | 38 | 3.0 | fine-denier | 1.0 | 38 | 50 | 50 | 236 | 5.0 | — | 30 or more |
| | | | | acrylic fibers | | | | | | | | |
| Example 4 | 0.1 | 38 | 3.0 | fine-denier | 1.0 | 38 | 30 | 70 | 220 | 5.0 | 91.3 | 30 or more |
| | | | | acrylic fibers | | | | | | | | |
| Example 5 | 0.1 | 38 | 3.0 | fine-denier | 1.0 | 38 | 5 | 95 | 230 | 4.2 | — | 30 or more |
| | | | | acrylic fibers | | | | | | | | |
| Example 6 | 0.1 | 38 | 3.0 | fine-denier | 1.0 | 38 | 90 | 10 | 200 | 4.6 | 89.6 | 30 or more |
| | | | | acrylic fibers | | | | | | | | |
| Example 7 | 0.1 | 38 | 3.0 | Y-shaped | 6.6 | 38 | 30 | 70 | 193 | 4.2 | — | 30 or more |
| | | | | acrylic fibers | | | | | | | | |
| Example 8 | 0.1 | 38 | 3.0 | side-by-side | 2.2 | 38 | 50 | 50 | 193 | 4.6 | — | 30 or more |
| | | | | acrylic fibers | | | | | | | | |
| Example 9 | 0.1 | 38 | 3.0 | side-by-side | 2.2 | 38 | 30 | 70 | 199 | 4.6 | — | 30 or more |
| | | | | acrylic fibers | | | | | | | | |
| Example 10 | 0.005 | 38 | 3.0 | regular | 2.2 | 51 | 50 | 50 | 280 | 5.0 | — | 30 or more |
| | | | | acrylic fibers | | | | | | | | |
| Example 11 | 0.005 | 38 | 3.0 | regular | 2.2 | 51 | 10 | 90 | 200 | 4.6 | — | 30 or more |
| | | | | acrylic fibers | | | | | | | | |
| Example 12 | 0.005 | 38 | 3.0 | Y-shaped | 6.6 | 38 | 50 | 50 | 200 | 4.6 | — | 30 or more |
| | | | | acrylic fibers | | | | | | | | |

TABLE 2

| | Short fibers A | | | | | | | | | | | |
|---|---|---|---|---|---|---|---|---|---|---|---|---|
| | | | amount of | Short fibers B | | | | | | | | |
| | single | length of | adhered | | single | length | Ratio of | Ratio of | | | Heat- | |
| | fiber | short | poly- | | fiber | of short | short | other | Bulki- | Soft- | reten- | # of neps |
| | fineness | fibers | siloxane | type of | fineness | fibers | fibers A | fibers | ness | ness | tion | (per 1 g of |
| | (dtex) | (mm) | (mass %) | fibers | (dtex) | (mm) | (mass %) | (mass %) | (mm) | (point) | rate (%) | wadding) |
| Example 13 | 0.005 | 38 | 3.0 | side-by-side | 2.2 | 38 | 50 | 50 | 200 | 4.6 | — | 30 or more |
| | | | | acrylic fibers | | | | | | | | |
| Example 14 | 0.1 | 3 | 3.0 | regular | 2.2 | 51 | 50 | 50 | 192 | 4.2 | — | 30 or more |
| | | | | acrylic fibers | | | | | | | | |
| Example 15 | 0.1 | 120 | 3.0 | regular | 2.2 | 51 | 50 | 50 | 210 | 4.6 | — | 30 or more |
| | | | | acrylic fibers | | | | | | | | |
| Example 16 | 0.1 | 6 | 3.0 | Y-shaped | 6.6 | 38 | 50 | 50 | 185 | 4.2 | — | 30 or more |
| | | | | acrylic fibers | | | | | | | | |
| Example 17 | 0.1 | 38 | 10.0 | regular | 2.2 | 51 | 30 | 70 | 275 | 5.0 | — | 30 or more |
| | | | | acrylic fibers | | | | | | | | |
| Example 18 | 0.1 | 38 | 0.01 | fine-denier | 1 | 38 | 30 | 70 | 210 | 4.6 | — | 30 or more |
| | | | | acrylic fibers | | | | | | | | |
| Example 19 | 0.8 | 38 | 3.0 | regular | 2.2 | 38 | 50 | 50 | 191 | — | 94.8 | 10~30 |
| | | | | acrylic fibers | | | | | | | | |
| Example 20 | 0.8 | 38 | 3.0 | regular | 2.2 | 38 | 80 | 20 | 180 | — | 93.7 | 10~30 |
| | | | | acrylic fibers | | | | | | | | |
| Example 21 | 0.8 | 38 | 3.0 | regular | 2.2 | 38 | 20 | 80 | 200 | — | — | 10~30 |
| | | | | acrylic fibers | | | | | | | | |
| Example 22 | 0.8 | 38 | 3.0 | cross-shaped | 2.2 | 38 | 50 | 50 | 206 | — | 93.8 | 10~30 |
| | | | | acrylic fibers | | | | | | | | |
| Example 23 | 0.8 | 38 | 3.0 | flat-type | 17 | 38 | 50 | 50 | 195 | — | 91.7 | 10~30 |
| | | | | acrylic fibers | | | | | | | | |
| Example 24 | 1.0 | 38 | 0 | side-by-side | 2.2 | 38 | 50 | 50 | 180 | 3.4 | — | 0 |
| | | | | acrylic fibers | | | | | | | | |

TABLE 3

| | Short fibers A | | | | | | | | | | | |
|---|---|---|---|---|---|---|---|---|---|---|---|---|
| | | | amount of | Short fibers B | | | | | | | | |
| | single | length of | adhered | | single | length | Ratio of | Ratio of | | | Heat- | |
| | fiber | short | poly- | | fiber | of short | short | other | Bulki- | Soft- | reten- | # of neps |
| | fineness | fibers | siloxane | type of | fineness | fibers | fibers A | fibers | ness | ness | tion | (per 1 g of |
| | (dtex) | (mm) | (mass %) | fibers | (dtex) | (mm) | (mass %) | (mass %) | (mm) | (point) | rate (%) | wadding) |
| Comp. | — | — | — | regular | 2.2 | 51 | — | 100 | 152 | 3.0 | — | 0 |
| Example 1 | | | | acrylic fibers | | | | | | | | |
| Comp. | — | — | — | polypropylene | 3.3 | 38 | — | 100 | 161 | — | 89.5 | 0 |
| Example 2 | | | | fibers | | | | | | | | |
| Comp. | — | — | — | cross-shaped | 2.2 | 38 | — | 100 | 178 | — | — | 0 |
| Example 3 | | | | acrylic fibers | | | | | | | | |
| Comp. | — | — | — | regular | 2.2 | 38 | — | 100 | 170 | — | 92.6 | 0 |
| Example 4 | | | | acrylic fibers | | | | | | | | |
| Comp. | — | — | — | polyester | 1.7 | 15 | — | 100 | 142 | — | 88.9 | 0 |
| Example 5 | | | | fibers | | | | | | | | |
| Comp. | — | — | — | polyester | 2.2 | 20 | — | 100 | 160 | — | 92.2 | 0 |
| Example 6 | | | | fibers (hollow) | | | | | | | | |
| Reference | 0.8 | 38 | 3.0 | — | — | — | 100 | 0 | 219 | — | — | 0 |
| Example 1 | | | | | | | | | | | | |
| Reference | — | — | — | PrimaLoft | — | — | 0 | 100 | 162 | — | 93.6 | 0 |
| Example 2 | | | | | | | | | | | | |
| Reference | — | — | — | Air Flake | — | — | 0 | 100 | 180 | — | 92.7 | 0 |
| Example 3 | | | | | | | | | | | | |
| Reference | 1.0 | 38 | 0.0 | — | — | — | 100 | 0 | 176 | 3.0 | 92.2 | 0 |
| Example 4 | | | | | | | | | | | | |
| Reference | 1.0 | 38 | 0.0 | Y-shaped | 6.6 | 38 | 50 | 50 | 165 | 3.4 | — | 0 |
| Example 5 | | | | acrylic fibers | | | | | | | | |

As shown in Tables 1˜3, excellent bulkiness and softness were exhibited in each of waddings of Examples 1˜24 prepared by using short fibers (A) specified by the present invention. By contrast, bulkiness and softness were observed to be low in each of the waddings of Comparative Examples 1˜7 prepared without using short fibers (A) specified by the present invention.

### Reference Example 1

A wadding was prepared by passing 100 mass % of acrylic fibers (made by Mitsubishi Rayon, item type: H616, single fiber fineness: 1.0 dtex, fiber length: 38 mm) through a fiber opener and by carding through a carding machine.

The wadding exhibited excellent bulkiness but showed a low compression recovery rate.

### Reference Examples 2, 3

Waddings were respectively prepared by using the fibers below. Evaluations of their bulkiness and heat-retention rate are shown in Table 3.
PrimaLoft (made by Albany Corporation, 100% polyester fibers)
   PrimaLoft is formed with hollow type polyester fibers having a larger fineness and with another type of polyester fibers having a smaller fineness. The fibers exhibited a high heat-retention rate, but low bulkiness.
Air Flake (made by Kurabo Industries Ltd., composite fibers of polyester and nylon)
   Air Flake is an interlaced wadding formed with long fibers and contains a core yam and a fancy yam longer than the core yarn, and the core yarn and fancy yam are interlaced to be integrated. The fancy yam is opened and made into loops. The fancy yarn is made of hollow fibers.

The wadding prepared with Air Flake was excellent in both bulkiness and heat-retention rate. However, since Air Flake is made of interlaced long fibers, it is difficult to arrange homogeneously as a wadding. Also, since it includes a core yarn, the texture is low.

### Reference Example 4

A wadding was prepared the same as in Example 24 except that only short fibers (A4) were used. The wadding showed an excellent heat-retention rate but a low level of bulkiness.

### Reference Example 5

A wadding was prepared the same as in Example 1 except that the fibers shown in Table 3 were used. The wadding showed a low level of bulkiness.

From the results above, waddings prepared in Reference Examples 1˜5 showed lower bulkiness than waddings prepared in the Examples of the present invention.

1. A wadding, comprising:
short fibers (A) with a single fiber fineness (a) of 0.001 dtex˜1.0 dtex at 5˜90 mass % of the total mass of the wadding,
wherein a heat-retention rate is 89% or higher, which is determined in accordance with JIS L1096:2010, Method A: measuring heat-retention rate (constant temperature method) for testing a sample piece prepared by substantially homogeneously stuffing 100 grams of the wadding into a pouch-shaped cover formed with two sheets of a 45 cm×45 cm square 100% cotton fabric and then by seaming the opening of the cover.

2. The wadding according to claim 1, wherein the bulkiness is 180 mm or greater.

3. The wadding according to claim 1, wherein the heat-retention rate is 93% or higher.

4. The wadding according to claim 1, further comprising short fibers (B) with a single fiber fineness (b) of 0.8 dtex˜20 dtex at 10˜95 mass % of the total mass of the wadding, wherein the single fiber fineness (a) of short fibers (A) and the single fiber fineness (b) of short fibers (B) satisfy a relationship of (b)≧1.5(a).

5. The wadding according to claim 4, wherein the single fiber fineness (b) of short fibers (B) is 1.3˜2.8 dtex.

6. The wadding according to claim 1, wherein the number of neps existing in 1 gram of the wadding is 30 or greater.

7. The wadding according to claim 1, wherein the single fiber fineness (a) of short fibers (A) is at least 0.001 dtex but less than 0.4 dtex.

8. The wadding according to claim 1, wherein the single fiber fineness (a) of short fibers (A) is at least 0.4 dtex but no greater than 1.0 dtex.

9. The wadding according to claim 1, wherein the length of short fibers (A) is 2060 mm, and the length of short fibers (B) is 20˜60 mm.

10. The wadding according to claim 1, wherein polysiloxane is adhered to short fibers (A) at 0.1˜15.0 mass % of the total mass of the short fibers (A).

11. The wadding according to claim 1, wherein short fibers (A) are acrylic fibers.

12. The wadding according to claim 1, further comprising heat-adhesive short fibers at 5˜10 mass % of the total mass of the wadding, wherein at least some of the heat-adhesive short fibers are adhered to short fibers (A).
